(19) United States
(12) Patent Application Publication
(10) Pub. No.: US 2002/0124774 A1
(43) Pub. Date: Sep. 12, 2002

(54) Composition for the impregnation of paper, method for the production thereof, impregnated paper and laminate comprising said impregnated paper

(75) Inventor: Mario Volpatti, Au am Rhein (DE)

Correspondence Address: SCULLY, SCOTT, MURPHY & PRESSER, 400 Garden City Plaza, Garden City, NY, 11530, US

(73) Assignee: Unidur GmbH, Burstadt (DE)

(21) Appl. No.: 10/014,674

(22) Filed: Dec. 11, 2001

Related U.S. Application Data
(63) Continuation of application No. PCT/EP00/05431, filed on Jun. 13, 2000.

(30) Foreign Application Priority Data
Jun. 11, 1999 (DE) 199 26 722.7

(51) Int. Cl. C08B 30/18

(52) U.S. Cl. 106/144.1; 536/46; 514/58; 516/100

(57) ABSTRACT

The invention relates to a composition which is especially used to impregnate paper, containing a binding agent, an aqueous polymer dispersion and glyoxal. The invention also relates to a method for the production of said composition, in addition to an intermediate produced which can be used in an advantageous manner and which contains glyoxal, water and a binding agent. The inventive compositions are particularly suitable for impregnating paper and can be used to produced decorative paper with improved properties.

### CROSS REFERENCE TO RELATED APPLICATION

This application is a continuation of International Application No. PCT/EP00/05431, filed on Jun. 13, 2000.

### BACKGROUND OF THE INVENTION

1. Technical Field

The present invention relates to a composition particularly useful for impregnating paper. In addition, the present invention relates to a process for preparing such a composition, impregnated papers and the use thereof.

2. Prior Art

Impregnated papers are widely used for decorating surfaces. Especially in the furniture industry, such papers are often used to finish surfaces. Such papers may be unicoloured or have certain décors such as wood grain printed thereon. Such papers offer the opportunity to give less attractive substrates such as chipboards a pleasant appearance at low cost.

When impregnated papers are sued for decorating surfaces in the furniture industry, i.e. as so-called décor papers, they must meet certain application technology requirements to permit processing of the substrates coated therewith on the one hand. On the other hand, the décor papers must be easy and inexpensive to manufacture.

As far as the application technology properties are concerned, the décor papers must meet certain mechanical requirements. This means they must be sufficiently resistant to water, have both the stiffness and flexibility suitable for processing and have sufficient core strength. Especially for the furniture industry, the so-called tear behaviour is also of particular importance. The tear behaviour is the tendency of the décor paper to tear beyond the edge of the substrate. Thus the tear behaviour is a measure of how well the décor paper may be processed. In a number of processing steps such as sawing, drilling, milling and such like, fraying of the glued-on film must be avoided. Rather, the impregnated fibre should break off at the processing edge so as to obtain optically pleasing results.

The impregnation of the paper, i.e. the impregnating agent used, has an essential influence on the above properties. In addition, the impregnating agent has a decisive influence on the optical properties, especially the depth of colour and the varnish firmness of the décor paper.

As far as the use in the furniture industry is concerned, increasing care has to be taken these days that the compositions used for impregnating décor papers are free of potentially harmful substances. In particular, it is desired to keep the impregnating agents free of formaldehyde.

Compositions free of formaldehyde, which are used for impregnating décor papers, are known from WO 95/17551, for example. This application proposes aqueous impregnating agents containing a cross-linkable polymer having a certain glass transition temperature and a binder. These prior art compositions free of formaldehyde already give useful results, but there is room for improvement especially with regard to the tear behaviour of décor papers made with such compositions. The same applies for the impregnating agents based on dextrin and a polymer dispersion as proposed by Südstärke GmbH, Schrobenhausen.

### SUMMARY OF THE INVENTION

Therefore, it is the object of the present invention to provide a composition free of formaldehyde for impregnating paper which combines the above-mentioned properties in the best possible manner and, in particular, permits the preparation of décor papers having special tear resistance.

The invention achieves this object by a composition containing a binder, an aqueous polymer dispersion and glyoxal.

It has been shown that the composition of the invention is particularly advantageous, because it permits the preparation of décor papers having excellent depth of colour and high varnish firmness. At the same time, the décor papers made with the composition of the invention have excellent tear resistance without sacrificing flexibility. As far as processing technology is concerned, the compositions of the invention are also especially advantageous, because they yield good results even at a low solids content and it is easy to saturate the paper to be impregnated with these compositions. Other advantages and characteristics of the present invention become evident from the following description.

### DETAILED DESCRIPTION OF THE PREFERRED EMBODIMENTS OF THE INVENTION

The compositions according to the invention contain a binder. Conventional binders may be used in the invention, water-soluble binders being preferred. Examples for such water-soluble binders are polyvinyl alcohols, gelatine, cellulose derivatives such as carboxy methyl cellulose, alginates, starch and starch derivatives and mixtures thereof. Water-soluble starch derivatives and especially dextrins are particularly preferred. Dextrins have the special advantage of being easily soluble in water and not requiring any additional step such as boiling.

In addition, the compositions of the invention contain an aqueous polymer dispersion. Again, polymer dispersions common for paper impregnation may be used. Dispersions containing cross-linkable polymers are advantageous, such as (meth)acrylate) polymers and copolymers of (meth)acrylate) monomers with suitable comonomers. The term “(meth)acrylates” means that both methacrylates and acrylates are suitable for the invention. Examples of suitable (meth)acrylate polymers are styrene (meth)acrylate copolymers, methyl, ethyl, propyl and butyl (meth)acrylates being suitable for use. Especially suitable are all monomers bearing reactive groups such as amino, hydroxyl or carboxyl groups which are capable of reacting with glyoxal.

According to the aqueous polymer dispersion may also contain additional polymer components such as polyester or polyurethane components. With these additional components, the properties of the impregnated paper may be adapted more easily to the pertinent requirements.

Polyurethane-based dispersions may be advantageously used especially for pre-impregnated materials, because they form excellent smooth surfaces.

The composition of the invention containing a binder, an aqueous polymer dispersion and glyoxal suitably has a viscosity of 10 to 15 sec. at 23° C. (measured with a Ford flow cup, 4 mm).

This is generally achieved when the overall solids content of the composition of the invention is in the range of 15 to 45wt.-%, preferably 20 to 40 wt.-% and especially preferably 22 to 30 wt.-% based on the dry mass.

Based on the dry mass of the composition of the invention, the polymer component may amount to 20 to 80 wt.-%, preferably 40 to 60 wt.-% and especially preferably 45 to 60 wt.-%. The amount of binder based on the dry mass of the composition of the invention may be 10 to 50 wt.-%, preferably 30 to 50 wt.-% and most preferably 35 to 40 wt.-%. The glyoxal portion of the dry mass of the composition of the invention may be 2 to 20 wt.-%, preferably 7 to 15 wt.-% and most preferably 9 to 12 wt.-%.

In addition to the above-mentioned components of the compositions of the invention, additional components may be incorporated as long as they do not affect the advantageous properties of the compositions of the invention. For example, it is possible to add pigments or fillers to the compositions of the invention.

The composition of the invention is suitably prepared by first charging the glyoxal with water. Then binder is added followed by incorporation of the polymer dispersion. This method is highly advantageous, because the technical glyoxal solutions generally used have a pH value of about 2 to 3.5 and are therefore highly acidic. Especially in case of dispersion containing (meth)acrylate, there would be a risk of the polymer coagulating if one were to mix the glyoxal directly with the polymer dispersion, so that no homogenous product is obtained. For incorporating the polymer dispersion, it is therefore advisable especially for dispersions containing (meth)acrylate to provide a mixture containing water, binder and glyoxal which has a pH of more than 6 and preferably in the neutral range, i.e. between pH 6 and 8.

The manner of preparing the compositions of the invention described above is also advantageous from an application technology point of view. Adding the polymer dispersion as the last component permits adjusting the characteristics of the compositions to the individual requirements and especially to the machinery available on the spot by selecting a suitable polymer dispersion. At the same time, storage stability improves noticeably. Another significant advantage in practical use, especially when starch and starch derivatives are used as binders, is the fact that the composition containing glyoxal, water and the pertinent binder is essentially not susceptible to contamination with fungi.

As mentioned above, the compositions of the invention are especially suitable for impregnating paper and particularly for impregnating décor papers. The papers used for this purpose are not particularly limited, but papers having an ash content of less than 18 wt.-% are especially preferred. It is known that papers having a low ash content are especially tear resistant. Accordingly, papers having an ash content of less than 15 wt.-% and especially less than 12 wt.-% are most preferred.

The weight per unit area of the papers to be impregnated is not especially limited; papers having a weight per unit area of 45 to 70 g/m² are suitable in any case.

The paper may be saturated with the composition of the invention according to conventional processes. The amount to be applied per square meter of paper depends on whether post-impregnation or pre-impregnation is carried out. The compositions of the invention are equally suitable for both methods.

As a rule, the proportion of the impregnation is 20 to 24 wt.-% in pre-impregnated materials and 25 to 35 wt.-% in post-impregnated materials based on the dry mass of the impregnation agent. Thanks to the invention, this proportion can be decreased considerably. For example, good properties were achieved with 18% for post-impregnated materials. Therefore, the composition of the invention permits the preparation of inexpensive décor papers saving resources without having to sacrifice quality.

The papers thus impregnated may be laminated on different substrates such as chipboards, fibre boards and such like by conventional methods. While doing so, it was found that the papers according to the invention may be glued particularly well, for example by using urea glues. This property is very important in practical use, because good and rapid gluing permits high production rates.

### EXAMPLES

In order to show the advantages of the present invention, the following six compositions were compared, all of which were adjusted to a solids content of 30 wt.-%.

TABLE 1

| Composition | Component(s) | Proportion in wt. % |
|---|---|---|
| 1 | S 305 D | 100 |
| 2 | S 305 D | 75 |
| | Licopol | 25 |
| 3 | S 305 D | 75 |
| | Glyoxal | 25 |
| 4 | S 305 D | 75 |
| | Licopol | 15 |
| | Glyoxal | 10 |
| 5 | S 305 D | 50 |
| | Licopol | 50 |
| 6 | Licopol | 100 |

Licopol is an aqueous dextrin solution having 50% of dry substance, available from Südstärke GmbH, Schrobenhausen. Acronal S 305 D is an n-butyl acrylate styrene copolymer available from BASF AG, Ludwigshafen (solids content 50 wt.-%). The glyoxal used was 40 wt.-% solution.

A décor paper from Munksjö, Italy, having the number 101465 and an area unit weight of 45 g/m² with an ash content of 13% and a porosity of 24 s measured by the Gurley method was impregnated with this composition. Impregnation was carried out by impregnating the paper with the impregnating solution, stripping off excess impregnating solution and drying at 150° C.

After that, the content of the impregnating agent in the impregnated paper was 25±2 wt.-% and was therefore in the boundary region of pre- and post- impregnated materials. During impregnation it was observed how well the paper took up the impregnating solution. The results are shown in table 2.

After that, the papers thus impregnated were painted with an acid-curable aminoplast varnish (corresponding to Type 9944.61, available from Plantag Chemie, Detmold). Then the papers were dried at 160° C. After that, the surface was examined and the gloss tested with an Ericsson Glossmeter at an angle of 60°. In addition, the flexibility of the impregnated and varnished papers was examined by folding. When the paper broke upon folding, it was classified as brittle.

In addition, the colour of the paper was determined relative to sample No. 2. These measurements were carried out with a Datacolor Spectrophotometer at 10°, i.e. the normal viewing angle.

After impregnation and varnishing, the tear resistance of the papers was also examined. For this purpose, a sample was adhered two-dimensionally to a chipboard by means of an aminoplast adhesive, part of the paper protruding over the edge of the chipboard by at least 20 mm in the cross-grain direction. The gluing temperature was 145° C., and the paper was pressed onto the board with 10 N/cm² for 15 s. After gluing, the protruding part of the paper was cut at 2 cm intervals so that protrusions of 2×2 cm resulted. These protrusions were then pulled rapidly in the direction of the edge of the chipboard at an angle of 45°. This test was carried out both directly after impregnation, i.e. at a time when the temperature was about 90°, and after cooling to room temperature. The resulting tears in the part of the paper bonded to the substrate were measured starting from the edge.

TABLE 2

| | | | CIELAB D65 | | | | | |
|---|---|---|---|---|---|---|---|---|
| | Take-up | Change | Colour | | Tearing | | | |
| Compo- | by the | in | Difference¹⁾ | | strength | | | |
| sition | paper | colour | DE | DH | hot | cold | Flexibility | Gloss |
| 1 | poor | grainy | 2.67 | 0.91 | 33 | 10 | good | 12.5 |
| | | surface, | | | | | | |
| | | lighter than 2, | | | | | | |
| | | more yellow | | | | | | |
| 2 | better | best colour, | 0.00 | 0.00 | 20 | 4 | good | 14.0 |
| | than 1, | somewhat | | | | | | |
| | worse | impure | | | | | | |
| | than 3 | | | | | | | |
| | and 4 | | | | | | | |
| 3 | good | brightness | 2.54 | 0.64 | 0 | 0 | brittle | 14.0 |
| | | like 1, good | | | | | | |
| | | surface | | | | | | |
| 4 | good | depth of | 0.24 | −0.08 | 2-3 | <1 | good | 14.5 |
| | | colour a little | | | | | | |
| | | less than 2 | | | | | | |
| 5 | worse | like 4, but | 0.85 | −0.37 | 11 | 3 | good | 13.0 |
| | than 3 | redder | | | | | | |
| | and 4 | | | | | | | |
| 6 | good | depth of | 1.63 | 0.18 | 8 | 3 | good | 7.0 |
| | | colour like 1, | | | | | | |
| | | but redder | | | | | | |

The above results show that formulation 4 of the invention has surprisingly favourable overall properties which cannot be obtained when just two components or only one of the components of the invention are used. The high tear resistance, the good surface gloss and the good flexibility of the papers impregnated according to the invention should be emphasized.

While the present invention has been particularly shown and described with respect to preferred embodiments thereof, it will be understood by those skilled in the art that the foregoing and other changes in forms and details may be made without departing from the spirit and scope of the present invention. It is therefore intended that the present invention not be limited to the exact forms and details described and illustrated, but fall within the scope of the appended claims.

1. A composition, especially for impregnating paper, containing a binder comprising dextrin, an aqueous polymer dispersion and glyoxal.

2. A composition according to claim 1 wherein the aqueous polymer dispersion contains at least one (meth)acrylate polymer.

3. A process for preparing a composition comprising feeding in glyoxal with water, adding a binder comprising dextrin, to obtain a mixture, and then finally adding an aqueous polymer dispersion to the mixture obtained.

4. A process for impregnating paper, comprising applying a composition according to claim 1 to a paper substrate.

5. An impregnated paper obtained by the process of claim 4.

6. A laminate comprising an impregnated paper according to claim 5 and a substrate.
